(19) United States
(12) Patent Application Publication
(10) Pub. No.: US 2003/0132921 A1
(43) Pub. Date: Jul. 17, 2003

(54) Portable sensory input device

(76) Inventors: Ilhami Hasan Torunoglu, Monte Sereno, CA (US); James D. Spare, San Francisco, CA (US); Michael A. Van Meter, Danville, CA (US); Shiraz M. Shivji, Saratoga, CA (US); Cyrus Bamji, Fremont, CA (US); Carlo Tomasi, Palo Alto, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/313,939

(22) Filed: Dec. 5, 2002

Related U.S. Application Data
(63) Continuation-in-part of application No. 09/502,499, filed on Feb. 11, 2000.
(63) Continuation-in-part of application No. 09/948,508, filed on Sep. 7, 2001.
(63) Continuation-in-part of application No. 10/245,925, filed on Sep. 17, 2002.
(63) Continuation-in-part of application No. 10/246,123, filed on Sep. 17, 2002.
(63) Continuation-in-part of application No. 10/115,357, filed on Apr. 2, 2002.
(63) Continuation-in-part of application No. 10/187,032, filed on Jun. 28, 2002.
(63) Continuation-in-part of application No. 10/179,452, filed on Jun. 24, 2002.
(60) Provisional application No. 60/339,234, filed on Dec. 7, 2001.
(60) Provisional application No. 60/163,445, filed on Nov. 4, 1999.
(60) Provisional application No. 60/231,184, filed on Sep. 7, 2000.
(60) Provisional application No. 60/382,899, filed on May 22, 2002.
(60) Provisional application No. 60/382,899, filed on May 22, 2002.
(60) Provisional application No. 60/281,314, filed on Apr. 3, 2001.
(60) Provisional application No. 60/337,086, filed on Nov. 27, 2001.
(60) Provisional application No. 60/300,542, filed on Jun. 22, 2001.

(51) Int. Cl. G09G 5/00

(52) U.S. Cl. 345/173

(57) ABSTRACT

An input device provides input to a portable electronic device. The device detects movement of a user's fingers on an inert work surface, and transmits signals representing the detected input to the electronic device. The input device can take any of several forms, including a cradle or protective cover that attaches to the electronic device, or a separate unit that transmits signals to the electronic device via a wired connection or wireless connection. In an embodiment, techniques are employed to properly position the input device despite user adjustment to the position of the electronic device. In an embodiment, further techniques are employed to maximize the stability of the input device and to protect its components from damage.

### CROSS-REFERENCE TO RELATED APPLICATIONS

This application claims priority from U.S. provisional patent application serial No. 60/339,234 for “Method and Apparatus for Stability and Alignment of a Portable Sensory Input Device,” filed Dec. 7, 2001, the disclosure of which is incorporated herein by reference.

The present application is a continuation-in-part of U.S. patent application Ser. No. 09/502,499 for “Method and Apparatus for Entering Data Using a Virtual Input Device,” filed Feb. 1, 2000, the disclosure of which is incorporated herein by reference, and which in turn claims priority from U.S. Provisional Patent Application Serial No. 60/163,445 for “Method and Device for 3D Sensing of Input Commands to Electronic Devices,” filed Nov. 4, 1999.

The present application is a continuation-in-part of U.S. patent application Ser. No. 09/948,508 for “Quasi-Three-Dimensional Method and Apparatus To Detect and Localize Interaction of User-Object and Virtual Transfer Device,” filed Sep. 7, 2001, the disclosure of which is incorporated herein by reference, and which in turn claims priority from U.S. Provisional Patent Application Serial No. 60/231,184 for “Application of Image Processing Techniques for A Virtual Keyboard System,” filed Sep. 7, 2000.

The present application is a continuation-in-part of U.S. patent application Ser. No. 10/245,925 for “Measurement of Depth from Thickness or Separation of Structured Light with Application to Virtual Interface Devices,” filed Sep. 17, 2002, the disclosure of which is incorporated herein by reference, and which in turn claims priority from U.S. Provisional Patent Application Serial No. 60/382,899 for “Measurement of Distance in a Plane from the thickness of a Light Beam from the Separation of Several Light Beams,” filed May 22, 2002.

The present application is a continuation-in-part of U.S. patent application Ser. No. 10/246,123 for “Method and Apparatus for Approximating Depth of an Object's Placement into a Monitored Region with Applications to Virtual Interface Devices,” filed Sep. 17, 2002, the disclosure of which is incorporated herein by reference, and which in turn claims priority from U.S. Provisional Patent Application Serial No. 60/382,899 for “Measurement of Distance in a Plane from the thickness of a Light Beam from the Separation of Several Light Beams,” filed May 22, 2002.

The present application is a continuation-in-part of U.S. patent application Ser. No. 10/115,357 for “Method and Apparatus for Approximating a Source Position of a Sound-Causing Event for Determining an Input Used in Operating an Electronic Device,” filed Apr. 2, 2002, the disclosure of which is incorporated herein by reference, and which in turn claims priority from U.S. Provisional Patent Application Serial No. 60/281,314 for “A Localization System Based on Sound Delays,” filed Apr. 3, 2001.

The present application is a continuation-in-part of U.S. patent application Ser. No. 10/187,032 for “Detecting, Classifying, and Interpreting Input Events Based on Stimuli in Multiple Sensory Domains,” filed Jun. 28, 2002, the disclosure of which is incorporated herein by reference, and which in turn claims priority from U.S. Provisional Patent Application Serial No. 60/337,086 for “Sound-Based Method and Apparatus for Detecting the Occurrence and Force of Keystrokes in Virtual Keyboard Applications,” filed Nov. 27, 2001.

The present application is a continuation-in-part of U.S. patent application Ser. No. 10/179,452 for “Method and Apparatus to Display a Virtual Input Device,” filed Jun. 22, 2001, the disclosure of which is incorporated herein by reference, and which in turn claims priority from U.S. Provisional Patent Application Serial No. 60/300,542 for “User Interface Projection System,” filed Jun. 22, 2001.

### BACKGROUND OF THE INVENTION

1. Field of the Invention

The present invention relates to input devices for portable electronic devices, and more particularly to data input devices that easily connect to such electronic devices, maintain positioning and orientation of sensitive components, and protect such components from damage. The invention further relates to various housings for such input devices that maximize portability and functionality.

2. Description of the Background Art

U.S. Pat. No. 6,323,942, for “CMOS Compatible 3-D Image Sensor”, the disclosure of which is incorporated herein by reference, discloses a three-dimensional imaging system including a two-dimensional array of pixel light sensing detectors and dedicated electronics and associated processing circuitry to measure distance and velocity data in real time using time-of-flight (TOF) data.

The related patent applications cross-referenced above disclose additional data input methods and apparatuses including direct three-dimensional sensing, planar range sensors, and vertical triangulation. Such techniques detect user input by sensing three-dimensional data to localize the user's fingers as they come in contact with a surface.

Since such input devices generally operate in connection with a portable electronic device, it is desirable for the input devices to be portable, durable, and easily connectable to the electronic device. It is further desirable for such input devices to have form factors that yield useful secondary functionality, such as support functions and/or protective functions.

What is needed is a portable device that can incorporate one or more of these data input methods and apparatuses to provide a useful package for providing input to an electronic device such as a personal digital assistant (PDA). What is further needed is a portable device that can be easily connected to such an electronic device in a simple and intuitive manner. What are further needed, then, are methods of operation associated with such a portable device.

The technology used to construct such a portable device often requires satisfaction of very difficult geometrical or mechanical constraints in order to ensure proper operation. These constraints mandate new mechanical alignment techniques and configurations. What are further needed, then, are systems and methods of manufacture for such portable sensory input devices that ensure conformance with the imposed constraints while fulfilling the design goals and usability for such input devices.

In addition, the various components of such input devices are often highly sensitive to variances in their positions and orientations with respect to the work surface. It is desirable that such input devices be constructed so as to minimize such variances and thereby optimize performance. It is further desirable to provide the user with the ability to adjust the position of the host electronic device without adversely affecting position or orientation of the components of the input device.

Furthermore, the input device components are often fragile and vulnerable to damage while being used or carried. What are further needed, then, are configurations and designs that protect such components without adversely affecting their performance.

### SUMMARY OF THE INVENTION

The present invention is directed toward a mechanical housing or package for an input device that employs data input techniques such as those described in the related patents and patent applications. The invention encompasses several types of housings that can form part of a mobile device, or that can be connected to a mobile device, for providing input thereto. The invention further encompasses input devices that are integrated into a mobile device.

The present invention further provides techniques for configuring components within a portable input device and reliably supporting the device to meet applicable tolerances and specifications to reliably operate the input sensing technology, while maintaining design goals and usability for such an input device. The invention solves these problems by providing manufacturing techniques and component placement that improves stability of the device, enables accurate location of parts within very small tolerances, and protects the device from external factors. The invention further provides techniques for making the position and orientation of internal sensing components independent from the position of the device itself. The invention further provides techniques for providing fine adjustment to the positions of the sensing components. The invention further provides techniques for protecting the internal sensing components from damage.

Accordingly, the present invention may be implemented as an input device for providing input to a portable electronic device, including: a sensor that detects movement of a user's fingers on a work surface and generates a signal responsive to the detected movement; a processor that receives and processes the detected signal; a port, that communicates the portable electronic device and transmits the processed detected signal to the portable electronic device; and a housing that contains the sensor, the processor, and the port.

### BRIEF DESCRIPTION OF THE DRAWINGS

FIG. 1 is a block diagram depicting an input device according to an embodiment of the present invention.

FIGS. 2A, 2B, and 2C depict an input device implemented in the form of a cradle, according to an embodiment of the present invention.

FIGS. 3A, 3B, 3C, and 3D depict an input device implemented in the form of a cover for a portable electronic device, according to an embodiment of the present invention.

FIGS. 4A and 4B depict an input device implemented in the form of a stylus, according to an embodiment of the present invention.

FIG. 5 depicts an input device implemented separately from a portable electronic device, and including a one-line display, according to an embodiment of the present invention.

FIGS. 6A, 6B, and 6C depict an input device embedded in a portable electronic device, according to an embodiment of the present invention.

FIG. 7 depicts a portable input device having integrated sensory input components.

FIG. 8 depicts a technique for mounting a component at a specific height within an input device, according to an embodiment of the present invention.

FIGS. 9A, 9B, and 9C depict a portable input device having a hinge, according to an embodiment of the present invention.

FIGS. 10A, 10B, and 10C depict a portable input device having integrated wireless capability, according to an embodiment of the present invention.

FIGS. 11A, 11B, and 11C depict a high-hinged stand for a portable input device, according to an embodiment of the present invention.

FIGS. 12A and 12B depict a stand with a fine-grain screw adjustment, according to an embodiment of the present invention.

FIGS. 13A and 13B depict a portable input device having a recessed design, according to an embodiment of the present invention.

The Figures depict preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF A PREFERRED EMBODIMENT

The following description of system components and operation is merely exemplary of embodiments of the present invention. One skilled in the art will recognize that the various designs, implementations, and techniques described herein may be used alone or in any combination, and that many modifications and equivalent arrangements can be used. Accordingly, the following description is presented for purposes of illustration, and is not intended to limit the invention to the precise forms disclosed.

Overall Design

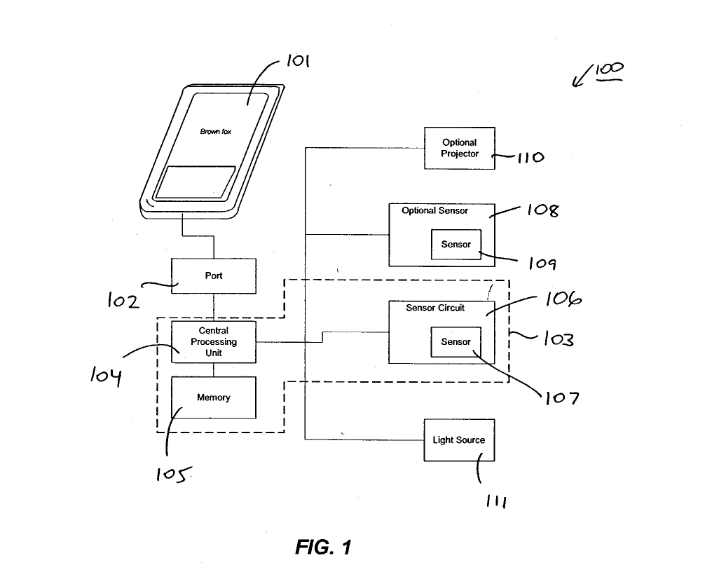

Referring now to FIG. 1, there is shown a block diagram of an exemplary portable input device 100 according to one embodiment of the present invention. In general, input device 100 operates to provide input to a host device 101, which may be a PDA, cell phone, or the like. Input device 100 can be enclosed in host device 101 or in a separate housing (not shown in FIG. 1). In one embodiment, the present invention provides mechanisms for implementing data input methods and apparatuses including direct three-dimensional sensing, planar range sensors, and vertical triangulation. Such techniques detect user input by sensing three-dimensional data to localize the user's fingers as they come in contact with a surface. In one embodiment, the surface is an inert work surface, such as an ordinary desktop. The work surface has a virtual layout that mimics the layout of a physical input device appropriate to the type of input being detected. For example, the layout may resemble a standard QWERTY keyboard for entering text, or it may resemble a piano keyboard for controlling a musical instrument.

In one embodiment, one or two (or more) sensor circuits 106, 108 are provided, each including a sensor 107, 109. Sensors 107, 109 may be implemented, for example, using charge-coupled device (CCD) and/or complementary metal-oxide semiconductor (CMOS) digital cameras as described in U.S. Pat. No. 6,323,942, to obtain three-dimensional image information. While many of the embodiments shown herein include one sensor 107, one skilled in the art will recognize that any number of sensors can be used, and thus references to “a sensor” are understood to include multiple sensor embodiments. It is beneficial, in some embodiments using three-dimensional sensing technology, to position sensors 107, 109 at the bottom of device 101 or device 100, so as to more accurately detect finger motions and contact with the work surface in the proximity of the bottom of such device. Alternatively, it may be preferable in some embodiments to position sensors 107, 109 at the side and towards the center or above device 101 or device 100. Such a location may be advantageous to provide an improved vantage point relative to the location of the user's fingers on the work surface when using two-dimensional sensors such as CCD or CMOS cameras.

Central processing unit (CPU) 104 runs software stored in memory 105 to detect input events, and to communicate such events to an application running on host device 101. CPU 104 communicates with device 101 via any known port 102 or communication interface, such as for example serial cable, Universal Serial Bus (USB) cable, Infrared Data Association (irDA) port, Bluetooth port, or the like. Light source 111, which may be implemented as part of device 100 or which may be an external source, illuminates the area of interest on the work surface so that sensors 107, 109 can detect activity. Optionally, projector 110 may display a keyboard layout or other guide on the work surface. It has been found to be advantageous, in some embodiments, to position projector 110 at the top of device 101 or device 100, so as to provide a sufficiently high vantage point to produce a sharp and in-focus pattern of the desired layout on the work surface.

In one embodiment, sensor circuit 106, sensor 107, memory 105, and CPU 104, as well as circuitries for controlling optional projector 110 and light source 111 are integrated into a single CMOS chip or multi-chip module 103, also referred to as a sensor subsystem 103. One skilled in the art will recognize that in alternative embodiments the various components of module 103 may be implemented separately from one another.

Embodiments of Input Device 100

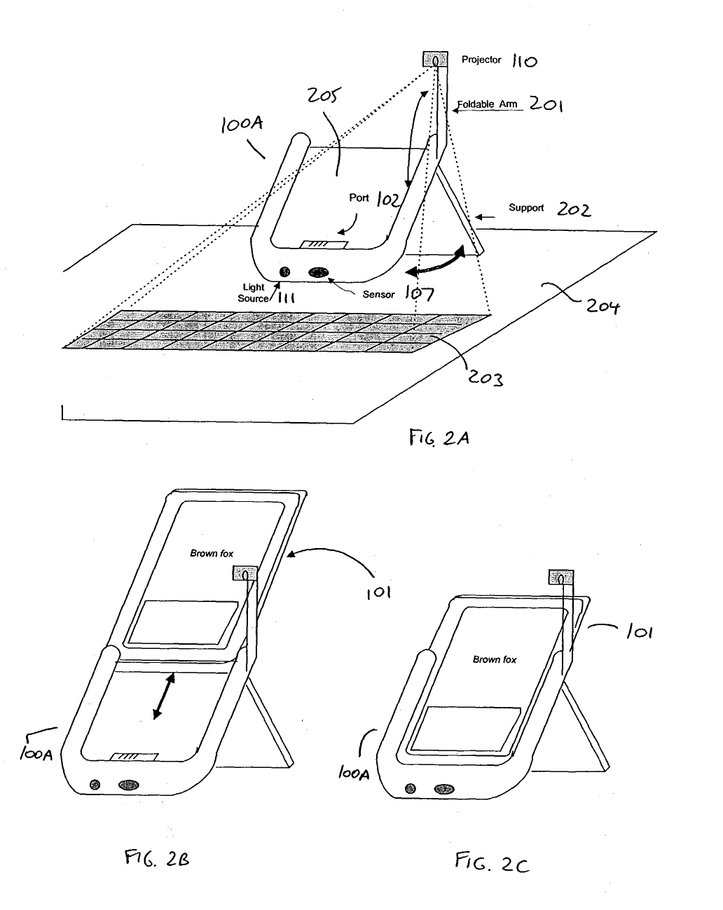

FIGS. 2A through 5 depict embodiments of the invention wherein input device 100 is provided in a separate housing from host device 101. One skilled in the art will recognize that the implementations shown in FIGS. 2A through 5 are merely exemplary, and that other embodiments of input device 100 may be provided without departing from the essential characteristics of the present invention. For example, many different variations in size and shape of device 100 may be contemplated.

Referring now to FIGS. 2A through 2C, there is shown an embodiment wherein input device 100 is implemented in the form of a cradle 100A. Host device 101 is connected to cradle 100A via port 102 adapted to make contact with device 101 when device 101 is seated in cradle 100A. In one embodiment, port 102 is located above sensor 107 at the bottom of rack area 205. Light source 111 and sensor 107 are located at the bottom part of cradle 100A so that sensor 107 is able to detect movement in the portion of work surface 204 in front of cradle 100A. CPU 104 and memory 105 (not shown in FIGS. 2A through 2C) may be located behind sensor 107 on a printed circuit board (not shown) contained with the structure of the cradle 100A. Projector 110, if included, is located in one embodiment at the top of foldable arm 201 attached to one side of cradle 100A. Projector 110 displays an image of a keyboard 203 (or other guide) to provide guidance to the user as to where to position his or her fingers when typing. When the user is about to enter input using device 100, he or she can pull projector 110 to an upright position as depicted in the Figures. When device 100 is not in use, the user can fold arm 201 forward and down. Alternatively, in another embodiment, arm 201 folds and unfolds automatically through a mechanical gearing, lever or other action. Foldable support 202 is movably attached to the back of cradle 100A by a hinge, and keeps cradle 100A and host device 101 (when seated in cradle 100A) in a predefined position. FIGS. 2B and 2C depict placement of host device 101 in cradle 100A according to one embodiment.

As can be seen from FIGS. 2A through 2C, this embodiment of the invention provides a portable input device 100 with very small form factor. In particular, foldable support 202 and arm 201 provide the ability to fold device 100 so that it can be more easily carried.

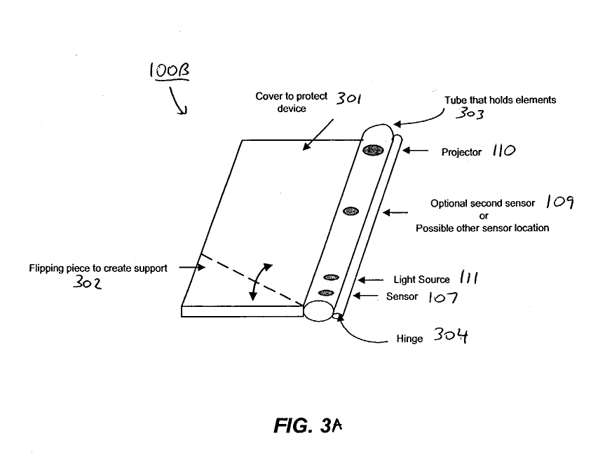

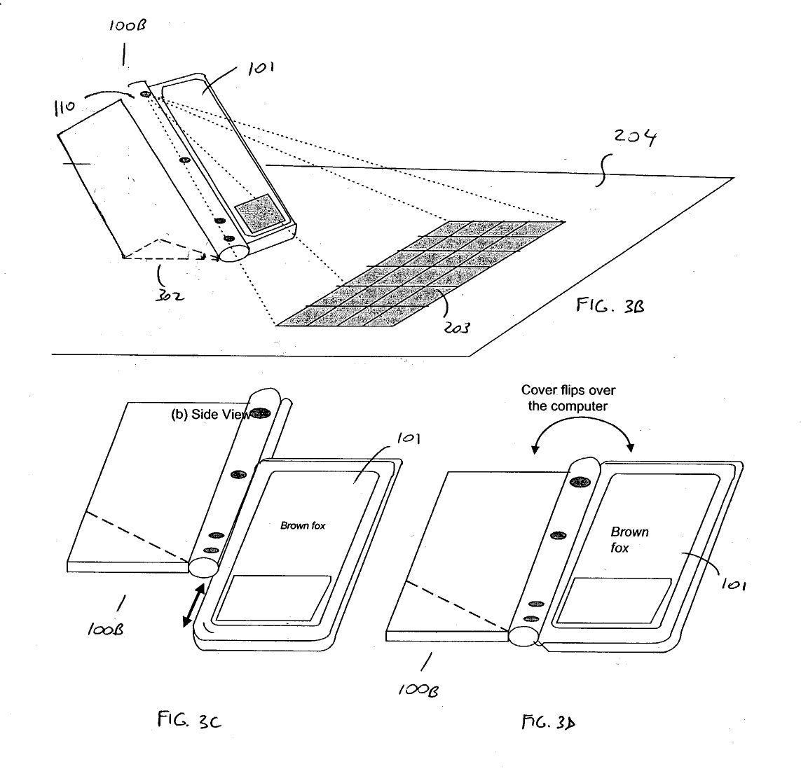

Referring now to FIGS. 3A through 3D, there is shown an embodiment wherein input device 100 is implemented in the form of a cover assembly 100B for host device 101. Cover assembly 100B includes a hard, flat cover 301 of an appropriate size and shape to suitably protect the face of host device 101 when cover 301 is in the closed position. In one embodiment, cover 301 is made of a material such as plastic or metal. Tube 303, attached to an edge of cover 301, forms a housing for sensor 107, light source 111, second sensor 109 (if included), and projector 110 (if included). Port 102 (not shown in FIGS. 3A through 3D) may be located anywhere in tube 303 that allows a connection with device 101. In embodiments using a wireless connection such as irDA or Bluetooth, port 102 may be positioned, for example, at or near the top of tube 303. In embodiments using a wired connection such as a serial connection, port 102 may be positioned, for example, at or near the bottom of tube 303.

Hinge 304, attached to tube 303, connects cover assembly 100B to host device 101. One type of mechanism for attaching hinge 304 to device 101 is depicted in FIGS. 3C and 3D.

In one embodiment, the manner in which hinge 304 attaches to host device 101 allows cover 301 to swing between a closed or an open position. In the closed position, cover 301 is positioned against the face of device 101, so as to protect device 101 when the assembly is being carried. In the open position, as depicted in FIG. 3B, cover 301 may be folded back to act as a support for device 101, so as to keep devices 101 and 100B in a desired position for input operations. Cover 301 may include a triangular element 302 that folds back to provide a stable support for devices 101 and 100B. Projector 110 may project keyboard image 203 on work surface 204. In this configuration, device 100B is sensitive to user input in the area in front of device 100B. Device 100B can be configured to tilt at any desired angle depending on the particular needs of the sensing and projection methods used.

One skilled in the art will recognize that the particular positioning of the various elements in FIGS. 3A through 3D is merely exemplary. For example, sensor 107 may be placed in a location other than near the bottom of tube 303, if desired or appropriate. Similar variations in positioning may be made for any of the elements shown in the Figures.

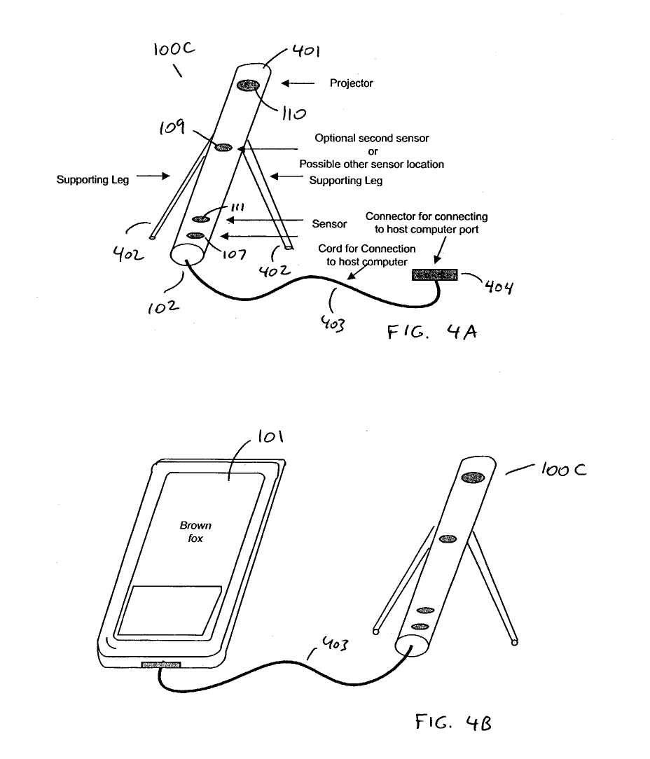

Referring now to FIGS. 4A and 4B, there is shown an embodiment wherein input device 100 is implemented in the form of a stylus 100C, such as a pencil- or pen-shaped unit. The cylindrical shape of stylus 100C makes it easy for a user to carry the device in a pocket, purse, or briefcase. In one embodiment, stylus 100C actually functions as a pen or pencil, in addition to providing the functionality for providing input to device 101.

In one version of this embodiment, generally cylindrical body 401 forms a housing for sensor 107, light source 111, second sensor 109 (if included), and projector 110 (if included). Of course body 401 need not be perfectly cylindrical, but rather may be ergonomically fashioned to be suitable for holding as a writing implement, if desired. Foldable supporting legs 402 movably extend from the body 401 to provide a stable support for body 401, and ensure that the components of device 100C are positioned correctly for proper operation. Legs 402 preferably have tips (not shown) which are rubberized or otherwise covered to provide enhanced friction for supporting the body 401. When not in use, the legs 402 preferably fold close against the body 401 into long recesses (not shown) so as to maintain a smooth profile across the surface of the body 401.

Port 102 may be provided at any location on body 401. In embodiments using a wireless connection such as irDA or Bluetooth, port 102 may be positioned, for example, at or near the top or side of body 401. In embodiments using a wired connection such as a serial connection, port 102 may be positioned, for example, at or near the bottom of tube 303. In wired embodiments, port 102 may connect with cord 403, which is coupled to connector 404 that in turn attaches to a port on device 101. Other schemes and arrangements for connecting device 100C to device 101 may be used.

One skilled in the art will recognize that the particular positioning of the various elements in FIGS. 4A and 4B is merely exemplary. For example, sensor 107 may be placed in a location other than near the bottom of body 401, if desired or appropriate. Similar variations in positioning may be made for any of the elements shown in the Figures.

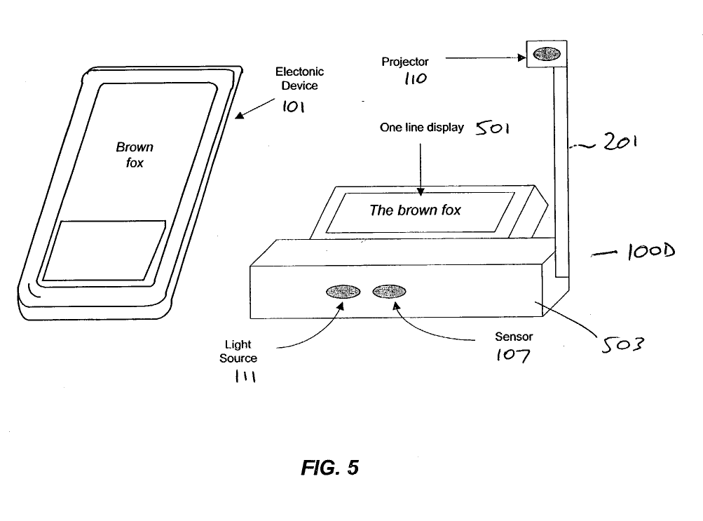

Referring now to FIG. 5, there is shown an embodiment wherein input device 100 is implemented as a separate unit 100D, coupled to device 101 via a wireless connection such as irDA or Bluetooth, or via a wired connection, such as a serial cable. Unit 100D includes a housing 503 containing its own display 501, which is illustrated as a one-line text display in FIG. 5, but which may be implemented as any type of display, including multi-line, text-based, graphical, or the like. Preferably, display 501 is an LCD or similar type display device. Display 501 allows the user to focus on the text being entered without having to look at device 101. Such a configuration facilitates faster typing and eliminates the need for the user to adjust to the use of different size fonts and sizes that may be provided on different host devices 101.

Housing 503 of unit 100D includes sensor 107, light source 111, and may include projector 110. Additional components described above, such as a second sensor 109, may also be included if desired. In one embodiment, sensor 107 and light source 111 are located near the bottom surface of housing 503, and projector 110 is located near the top of foldable arm 201 movably attached to the side of the housing 503. Housing 503 contains the relevant circuitry illustrated in FIG. 1 for the unit. Housing 503 is shown to be generally rectangular for the purposes of explanation of this embodiment, but in practice, housing 503 may have other generally shapes with greater aesthetic appearance. One skilled in the art will recognize that the invention may be practiced using other placements and configurations for the various components. Port 102 (not shown in FIG. 5) for communication with device 101 may be located, for example, on one side of unit 100D or on any other surface, or a wired connection may be implemented using a wire attached to one side of unit 100D.

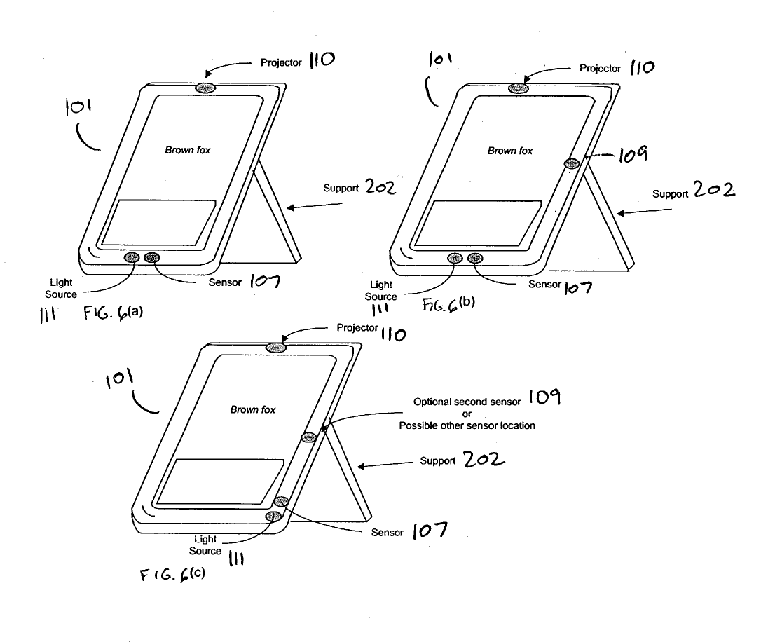

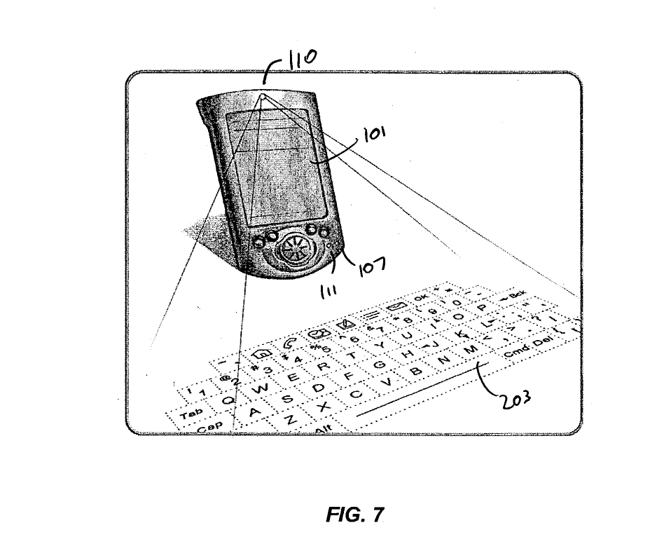

Referring now to FIGS. 6A through 6C and FIG. 7, there is shown an embodiment wherein the input device of the present invention is embedded within host device 101. Although the Figures show device 101 as a PDA-type device, one skilled in the art will recognize that the input device of the present invention may be embedded in any suitable host device 101, including for example a cell phone, handheld computer, pager, electronic instrument, data acquisition device, and the like. That is to say, the host device 101 can be any type of electronic device for which keyboard like data-entry is desirable, regardless of the particular type of data being entered, or its particular application environment.

Embedding the components of the input device in a host device 101 allows sharing of certain components of device 101, such as the CPU and/or memory of device 101. Such an arrangement also eliminates the need for communication port 102. The embedded arrangement thereby reduces the cost and the power consumption of the input device of the present invention.

FIG. 6A depicts an embodiment wherein sensor 107 and light source 111 are embedded near the bottom of device 101, while projector 110 (if included) near the top. In one embodiment, support 202 is included in order to allow device 101 to be tilted at a desired angle. Support 202 thereby improves the readability of the display of device 101, and further improves operability of the present invention by maintaining proper positioning of the various components of the invention. In one embodiment, support 202 is foldable.

It has been found advantageous, though not necessary, to position projector 110 near the top of device 101, so that projector 110 has a sufficiently high vantage point relative to the work surface to produce a clear and sharp keyboard image 203 on the work surface. When sensor 107 or, 109 is a three-dimensional sensor, it has been found advantageous, though not necessary, to position sensor 107 or 109 near the bottom of device 101 so as to better detect movement of the user's fingers. When sensor 107 or 109 is a two-dimensional sensor employing for example a CCD or CMOS camera, it has been found advantageous, though not necessary, to position sensor 107 or 109 near the top of device 101 so as to provide a better vantage point to perform three-dimensional measurements' on the two-dimensional image detected by sensor 107 or 109.

FIGS. 6B, 6C, and 7 illustrate different configurations and positioning of the sensor(s) 107, 109, light source 111, and projector 110. These alternative configurations are merely exemplary; one skilled in the art will recognize that the present invention may be practiced with many different configurations and positioning of the components.

Manufacturing Techniques

In all of the above implementations of the present invention, it is beneficial to position the various components (such as sensors 107, 109, light source 111, and projector 110) according to tight geometrical constraints within the unit. For example, in some embodiments, it is desirable to position such components very close to the top of an enclosure or housing, or very close to the bottom, or within specific mechanical tolerances. In one aspect, the present invention includes techniques for ensuring that such constraints and tolerances are met, without degrading the ruggedness of input device 100 or negatively affecting the usability of input device 100.

Accordingly, in one embodiment of the present invention, input device 100 is manufactured using one or more methods for ensuring optimal geomechanical configuration of the components.

For illustrative purposes, the following manufacturing techniques and mechanisms are described with respect to an input device 100 that is separate from and/or detachable from host device 101. However, one skilled in the art will recognize that any of the following techniques and mechanisms, or any combination thereof, may be used in connection with host device 101 itself, or with any electronic device. In particular, the techniques and mechanisms described herein may be used in connection with electronic devices that integrate the input functionality described herein and/or that are described in the related patents and patent applications. One skilled in the art will recognize that the following techniques and mechanisms can advantageously improve any electronic devices for which improved accuracy, stability, and durability are desired. Mounting a component within ultra-close proximity to the supporting surface

For components that are to be positioned very close to an edge of device 100, so that when in use they are located in close proximity to the work surface, one or more of the following manufacturing methods may be used:

a. Recess or completely cut out the sidewall of the packaging so that it is not as thick in the area in which the component is to be positioned. For instance, common design guidelines dictate that, for many consumer electronic devices such as cell phones PDAs, and the like, a plastic wall of at least 3 mm thickness be used. Recessing the sidewall can decrease its thickness to less than 3 mm, such as for example to 1 mm or 2 mm, so as to allow placement of a component very close to the edge of device 100. Alternatively, the sidewall can be cut out at the location at which the component is to be placed.

b. Shave or otherwise curtail a dimension of the component so as to reduce its size. The amount of material eliminated from the component is carefully determined so that the size reduction does not affect the operation of the component or of device 100. In embodiments where light source 111 is reduced in size in this manner, a specially designed film may be added to the shaved or curtailed section so as to prevent light from escaping and causing a safety, operational, or regulatory problem.

Mounting a Component at a Specific Height Within the Device

Referring now to FIG. 8, there is shown a technique for mounting a component 801 so that it is positioned at a specific vertical elevation with respect to work surface 204. Component 801 may represent projector 110, sensor 107 or 109, or any other component of device 100.

When a specific vertical elevation is specified for a component 801, the following method is used in one embodiment to determine the optimal mounting location 802 within device 100.

a. The desired vertical elevation (E) for optimal performance of component 801 is noted.

b. Device 100 in which component 801 is to be mounted (or some representation of device 100, such as an electronic representation or physical prototype) is positioned on top of work surface 204 (or some other flat surface) and adjusted to the optimal viewing angle.

c. The optimal viewing angle between the face of device 100 and work surface 204 is recorded. This angle is represented in FIG. 8 as A.

d. The location of component 801 within the device is now determined to be L=E /sin(A). L represents the desired distance of component 801 from the bottom of device 100, measured along the plane of the device.

One skilled in the art will recognize that the described technique can be employed for any device 100 in which components 801 are to be mounted in a location that provides a specific elevation with respect to a work surface 204.

In addition, as vertical elevation is generally specified for a given component 801, the described method may be used in reverse to generate specifications for such components 801. Thus, for example, if the vertical elevation (and hence the value of L) is known for a projector 110, design considerations such as the brightness of the image, size of the image, and distance of the projected image from the device can be chosen with the eventual position of projector 110 in mind.

Making the Supporting Structure of the Components Independent of the Angle of the Display

As indicated above, in many embodiments the location and positioning of the various components of device 100 is subject to specific requirements as dictated by the specifications of the components. However, in actual use, device 100 may be positioned and configured in different ways by different users. For example, while some components carry specific requirements as to their vertical elevation with respect to work surface 204, different users may wish to adjust the height and angle of their device 100 to match their various needs.

In order to ensure that components are properly positioned even when the user adjusts the height and/or angle of device 100, in one embodiment, device 100 includes a structure for supporting the components that is independent from the user-configurable aspects of the device 101 to which it communicates. This is accomplished using one or more of the following arrangements.

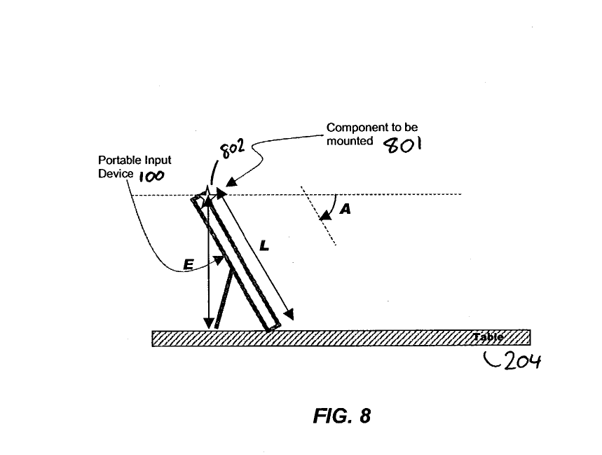

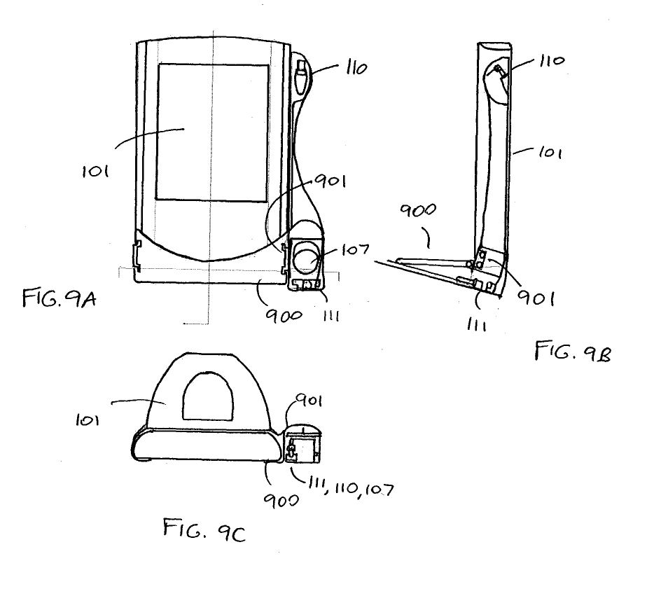

Referring now to FIGS. 9A, 9B, and 9C, there is shown an embodiment of the present invention that employs a hinge 901 to permit angular freedom. FIG. 9A shows a front view of the embodiment, FIG. 9B shows a side view, and FIG. 9C shows a top view. The angle of the device display is decoupled from the structure that determines the orientation of the components. In the depicted embodiment, which is intended for use with a PDA or other host device 101, stand 900 of the device holds the structure of the components at a fixed angle but is attached to host device 101 with a hinge 901. Hinge 901 provides a mechanism for decoupling the structure housing the position-sensitive components of device 100 from host device 101, so that the position of host device 101 can be adjusted according to the user's wishes without affecting the orientation, placement, or structure of the components of device 100.

In one embodiment, hinge 901 is implemented using a mounting to rotatably attach two pieces so that they can swivel with respect to one another, in a design similar to that used to attach scissor components, or alternatively in a design similar to that used in camcorders for attaching liquid crystal display (LCD) screens. In another embodiment, hinge 901 is implemented at a bottom surface using two pieces attached to a base/cradle, in a design similar to that used in an accelerator pedal on a car.

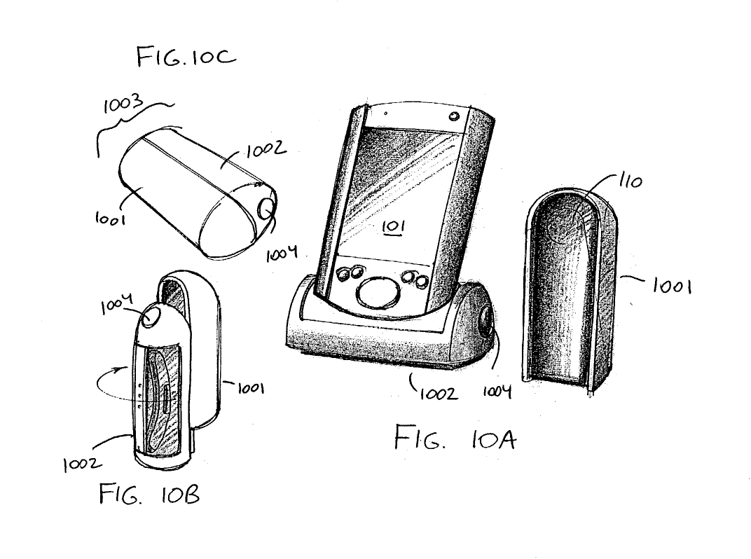

Referring now to FIGS. 10A through 10C, there is shown an embodiment of the present invention wherein device 100 is implemented as a tower 1001 and cradle 1002. Tower 1001 contains projector 110, sensors 107, 109 (not shown), sensor circuits 106, 108 (not shown), and light source 111 (not shown), if included. Cradle 1002 contains CPU 104 (not shown), memory 105 (not shown), and port 102 (not shown). Tower 1001 communicates with cradle 1002 via a wireless communication protocol such as Bluetooth or infrared. Cradle 1002 interfaces with host device 101 via port 102. In one embodiment, host device 101 is physically supported by cradle 1002 at an angle that is suitable for user interaction with host device 101. In one embodiment, cradle 1002 is adjustable so that host device 101 can be positioned at any desired angle. The embodiment of FIGS. 10A through 10C advantageously allow the user to reposition host device 101 and cradle 1002 without affecting tower 1001, which can maintain an optimal position for proper functioning of its various components.

In one embodiment, as shown in FIGS. 10B and 10C, cradle 1002 and tower 1001 can be attached to one another to form assembly 1003, which is compact and easy to carry. In one embodiment, the user presses release button 1004 to separate components 1002 and 1001; release button 1004 may also be used for releasing host device 101 from cradle 1002.

Mechanisms for Ensuring Stability and Ruggedness of the Supported Device

As discussed above, in some embodiments the sensory technology employed in input device 100 is sensitive to deviation in horizontal and vertical angular position from the flat surface on which it is supported. In general, it is beneficial to maintain a precise orientation of device 100 with respect to work surface 204 so as to ensure proper operation and maximum usability. One benefit to maintaining such orientation is to preserve the optimal lookdown angles of components such as projector 110, sensors 107, 109, and light source 111. Accordingly, in the following embodiments, input device 100 is constructed according to a design that improves stability, so as to ensure that the positions of the components of device 100 remain within specified tolerances. In addition, these configurations serve to reduce susceptibility to vibrations.

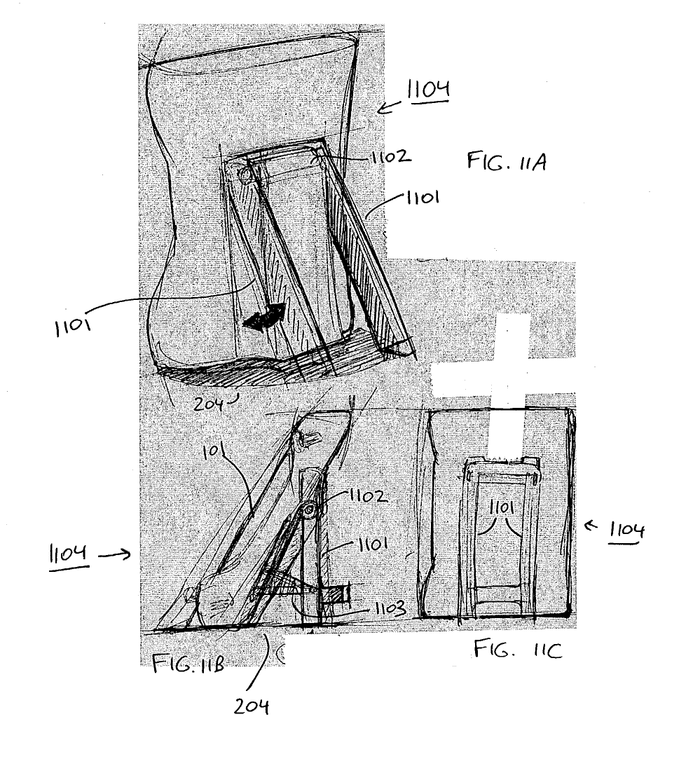

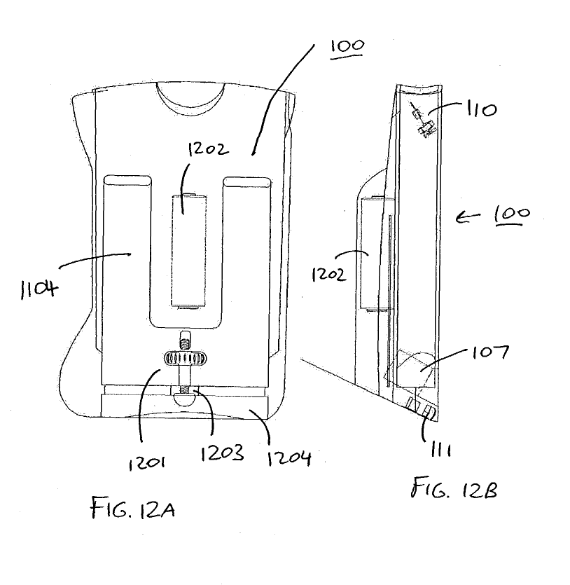

Referring now to FIGS. 11A, 11B, and 11C, there is shown an embodiment wherein device 100 includes a stand 1104 that supports host device 101 using two legs 1101 connected to host device 101 (or to a cradle component that holds host device 101) via hinge 1102. FIG. 11A shows an oblique rear view of the embodiment, FIG. 11B shows a side view, and FIG. 11C shows a rear view. Hinge 1102 is positioned at least ⅓ above the bottom of host device 101, and opens so that the opening of hinge 1102 points toward work surface 204. In some embodiments, hinge 1102 may be positioned even higher to further improve stability. A spring-loaded or dampening mechanism (not shown) may be further used to ensure that hinge 1102 opens all the way, ensuring proper extension and support. Stand-stop 1103 may be included to prevent stand 1104 from extending beyond a desired limit. A design such as that depicted in FIGS. 11A through 11C provides improved stability and helps to ensure that the position of device 100 does not vary beyond acceptable tolerances.

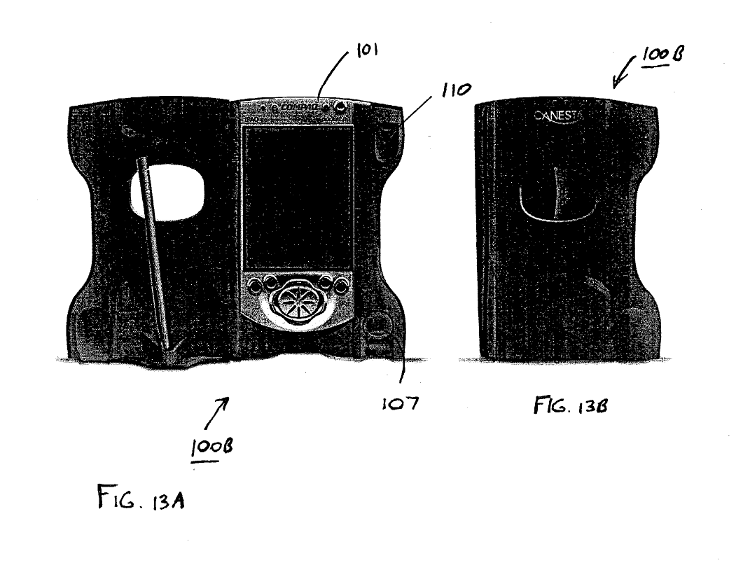

In one embodiment, one or more support elements, such as stand 1104, are adjustable so that the user can optimize the position of device 100 for maximum performance. Referring now to FIGS. 12A and 12B, there is shown an embodiment wherein device 100 includes a stand 1104 that supports host device 101 and contains a screw-thread adjustment knob 1201. FIG. 12A shows a rear view of the embodiment, while FIG. 12B shows a side view. In one embodiment, knob 1201 is located at the hinge or on the back of stand 1104. Turning knob 1201 causes screw thread 1203 to rotate and thereby extend leg extender 1204. The position of leg extender 1204 controls the angle of stand 1104, which in turn affects the overall tilt of device 100 and the lookdown angle of its components. Knob 1201 allows the user to make necessary adjustments to account for different operating environments or work surfaces, and/or to account for changes in the tolerances or desired positions of the various components of device 100 over time. Knob 1201 allows adjustments to be made to accommodate any changes in angular orientation, and provides the ability to make fine-grained adjustments when needed. In one embodiment, device 100 includes a calibration mode (not shown) that facilitates user adjustment of knob 1201 to an optimal position.

One skilled in the art will recognize that screw-thread adjustment knob 1201 is merely an example of a technique for providing adjustability in the position and orientation of the components of device 100. Battery 1202 is an optional component that is shown in FIGS. 12A and 12B for illustrative purposes only.

Protection of Optical Surfaces

In one embodiment, which may be combined with features of the embodiments described above, the invention includes one or more of the following features for improving the resistance of device 100 to scratches, touches, and other abrasions. In particular, in one embodiment sensors 107, 109 include lenses (not shown) that are particularly vulnerable to damage. By protecting these lenses and other components, the following features improve the durability, reliability, and performance of device 100 even under adverse conditions.

Lens design. In one embodiment, lenses of sensors 107, 109 are designed so that particularly sensitive surfaces are on the interior of the design, facing the silicon, as opposed to facing the external surface.

Protective Coating. In one embodiment, a thin chemical or plastic film protective coating is applied to the exterior surfaces of lenses of sensors 107, 109. The coating used for this purpose may be Filtron™ or a similar alternative.

Protective Shrouds. In one embodiment, a protective shroud, such as an “eyebrow” or other “lip” is made around the lenses of sensors 107, 109 so that it is difficult for the user to inadvertently make contact with the lenses with items that may scratch them (such as a finger, or items in a purse, or the like).

Recessed Design. Referring now to FIGS. 13A and 13B, there is shown an embodiment wherein device 100 is implemented as a cover 100B, similar to that of FIGS. 3A through 3D. Sensor 107 is recessed so that it is impossible or difficult for most objects to come in contact with the lens of sensor 107. In the illustration, projector 110 is similarly recessed for protection. FIG. 13B depicts device 100B, having recessed design, in a closed position. One skilled in the art will recognize that a similar technique can be employed for other variations and configurations of device 100, including the cradle design and the separate unit design as described above.

One skilled in the art will further recognize that any or all of the protective techniques listed above can be applied to any components of device 100, and are not limited in their applicability to sensors 107, 109. For example, the techniques may be used to protect lenses of projector 110, light source 111, or any other components.

The above-described designs for input devices 100 may be employed alone or in any combination, to provide the various advantages detailed above. The invention thus provides an input device 100 that is convenient, easy to use and carry, durable, and that maintains proper positioning and orientation.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

As will be understood by those familiar with the art, the invention may be embodied in other specific forms without departing from the spirit or essential characteristics thereof. For example, the particular architectures depicted above are merely exemplary of one implementation of the present invention. The functional elements and method steps described above are provided as illustrative examples of one technique for implementing the invention; one skilled in the art will recognize that many other implementations are possible without departing from the present invention as recited in the claims. Likewise, the particular capitalization or naming of the modules, protocols, features, attributes, or any other aspect is not mandatory or significant, and the mechanisms that implement the invention or its features may have different names or formats. In addition, the present invention may be implemented as a method, process, user interface, computer program product, system, apparatus, or any combination thereof. Accordingly, the disclosure of the present invention is intended to be illustrative, but not limiting, of the scope of the invention, which is set forth in the following claims.

What is claimed is:

1. An input device for providing input to a portable electronic device, comprising:
a sensor, for detecting movement of a user's fingers on a work surface, and for generating a signal responsive to the detected movement;
a processor, coupled to the sensor, for receiving and processing the detected signal;
a port, coupled to the processor, for communicatively coupling to the portable electronic device and transmitting the processed detected signal to the portable electronic device; and
a housing, for containing the sensor, the processor, and the port.

2. The input device of claim 1, further comprising:
a projector, contained within the housing, for projecting a keyboard guide onto the work surface.

3. The input device of claim 1, further comprising:
a light source, contained within the housing, for illuminating the work surface.

4. The input device of claim 1, wherein the housing is adapted to form a cradle for detachably supporting the portable electronic device.

5. The input device of claim 4, further comprising:
a hinge, coupled to the housing, for maintaining a position for the sensor relative to the work surface, independently of variation in the position of the portable electronic device relative to the work surface.

6. The input device of claim 4, further comprising:
at least one support member, for supporting the housing and the portable electronic device when attached.

7. The input device of claim 6, wherein the support member is adjustable to vary the position and orientation of the housing.

8. The input device of claim 1, wherein the housing is adapted to form a cover that is closable over a front surface of the portable electronic device.

9. The input device of claim 1, further comprising:
a cable, for attaching the port to the portable electronic device.

10. The input device of claim 1, wherein the port transmits the processed detected signal to the portable electronic device via a wireless communication medium.

11. The input device of claim 1, further comprising:
a display, for outputting a representation of the processed signal.

12. The input device of claim 1, wherein the portable electronic device and the input device are integrated into a single device, and wherein the housing contains both the portable electronic device and the input device.

13. The input device of claim 1, wherein the sensor comprises a lens having a protective coating.

14. The input device of claim 1, wherein the sensor comprises a lens, and wherein the housing comprises a protective shroud proximate to the lens.

15. The input device of claim 1, wherein the sensor comprises a lens, and wherein the housing comprises a recessed opening for the lens.

16. The input device of claim 1, wherein the work surface is inert.

17. The input device of claim 1, wherein the housing is adapted to form a case that may be detachably coupled with the portable electronic device.

18. A portable electronic device having integrated input functionality, the device comprising:
a sensor, for detecting movement of a user's fingers on a work surface, and for generating a signal responsive to the detected movement;
a processor, coupled to the sensor, for receiving and processing the detected signal as input for the electronic device; and
a housing, for containing both the sensor and the processor.

19. The portable electronic device of claim 18, further comprising:
a projector, contained within the housing, for projecting a keyboard guide onto the work surface.

20. The portable electronic device of claim 18, further comprising:
a light source, contained within the housing, for illuminating the work surface.

21. The portable electronic device of claim 18, further comprising:
a hinge, coupled to the housing, for maintaining a position for the sensor relative to the work surface, independently of variation in the position of the portable electronic device relative to the work surface.

22. The portable electronic device of claim 18, further comprising:
at least one support member, for supporting the housing and the portable electronic device when attached, wherein the support member is adjustable to vary the position and orientation of the housing.

23. The portable electronic device of claim 18, wherein the sensor comprises a lens having a protective coating.

24. The portable electronic device of claim 18, wherein the sensor comprises a lens, and wherein the housing comprises a protective shroud proximate to the lens.

25. The portable electronic device of claim 18, wherein the sensor comprises a lens, and wherein the housing comprises a recessed opening for the lens.

26. The portable electronic device of claim 18, wherein the work surface is inert.
